(19) United States
(12) Patent Application Publication
(10) Pub. No.: US 2023/0298783 A1
(43) Pub. Date: Sep. 21, 2023

(54) Coaxial Cable With A Braided Si02 Core

(71) Applicant: Carlisle Interconnect Technologies, Inc., St. Augustine, FL (US)

(72) Inventor: Ralph D. Schafer, Douglassville, PA (US)

(21) Appl. No.: 18/185,150

(22) Filed: Mar. 16, 2023

Related U.S. Application Data
(60) Provisional application No. 63/320,395, filed on Mar. 16, 2022.

(51) Int. Cl. H01B 7/29; H01R 13/52; H01B 1/08; H01B 1/16

(52) U.S. Cl. CPC H01B 7/292; H01R 13/5202; H01B 1/08; H01B 1/16

(57) ABSTRACT

A cable includes a center conductor and at least one layer formed of silicon dioxide fibers that are braided around the center conductor to form a braided dielectric core layer over the center conductor. An outer conductor layer is formed over the braided silicon dioxide core layer either as a wrapped tape or a semi-rigid conductor. In flexible embodiments of the cable, one or more outer strength layers and jackets may be applied over the outer conductor layer. In embodiments of the invention, the dielectric core layer includes at a plurality of sublayers of silicon dioxide fibers wherein each of the sublayers is successively braided on a previous sublayer.

### CROSS-REFERENCE TO RELATED APPLICATIONS

This application claims the benefit of priority to U.S. Provisional Patent Application Ser. No. 63/320,395 filed Mar. 16, 2022 (pending), the disclosure of which is incorporated by reference herein.

### TECHNICAL FIELD OF THE INVENTION

The invention relates generally to coaxial cables and more specifically to coaxial cables that are able to operate at high temperatures while still maintaining desirable electrical properties.

### BACKGROUND OF THE INVENTION

Existing coaxial cables that are meant to be temperature stable over a significant range of temperatures have used certain dielectric materials. Specifically, high temperature cables have been constructed using porous extruded amorphous or crystalline SiO₂ as a dielectric core that is extruded around the center conductor. The extruded core is usually bound in a semi-rigid cable with welded and hermetically sealed connectors. In such cable construction, with extruded cores using SiO₂, the cable core tends to be hydroscopic and thus easily absorbs moisture over time. This is a feature of the construction of the core, but the hydroscopic nature of the core can adversely change the loss characteristics of such a cable. In order to prevent the absorption of moisture, current high temperature coaxial cables require a hermetic seal at the end of the cable to reduce the moisture absorption and thereby prevent the change in the loss characteristic of the cable over time. The additional loss can have a drastic impact on the overall electrical performance of the cable and attenuate the signals handled by the cable in an undesirable way.

The SiO₂ core used in the construction of existing coaxial cable is extruded first. Then the extruded core is loaded into a semi-rigid cable, and the outer cable jacket is sunk down over the extruded core. The extruded SiO₂ core tends to be brittle. Therefore, in the cable construction process, there can be significant issues when the semi-rigid cable is bent into its final position. Specifically, the brittle core may crack, which allows for a direct line of sight from the center conductor to the outer conductor in the cable. Such a defect can lead to failures in dielectric breakdown, to problems with voltage standing wave ratio and to increased signal insertion loss, thus leading to degradation in performance. If the defect is significant, it can even lead to catastrophic failure of the coaxial cable.

### SUMMARY OF THE INVENTION

A cable includes a center conductor and at least one layer formed of silicon dioxide fibers that are braided around the center conductor to form a braided dielectric core layer over the center conductor. An outer conductor layer is formed over the braided silicon dioxide core layer. In some embodiments of the cable, one or more outer strength layers and jackets may be applied over the outer conductor layer. In a particular embodiment of the invention, the dielectric core layer includes t a plurality of sublayers of silicon dioxide fibers wherein each of the sublayers is successively braided on a previous sublayer. The sublayers may be braided using differing braiding parameters to provide improved coverage over the center conductor. The outer conductor layer might include a tape wrapped around the braided dielectric core layer. Alternatively, a semi-rigid outer conductor may cover the center conductor and braided dielectric core layer.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a perspective view, in partial cross-section, of a cable in accordance with an embodiment of the invention.

FIG. 2 is a cross-sectional view of the cable of FIG. 1.

FIG. 3 is a perspective view, in partial cross-section, of a cable in accordance with another embodiment of the invention.

FIG. 4 is a cross-sectional view of the cable of FIG. 2.

FIG. 5 is a perspective view, in partial cross-section, of a cable in accordance with another embodiment of the invention.

FIG. 6 is a cross-sectional view of the cable of FIG. 5.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE EMBODIMENTS OF THE INVENTION

The present invention is directed to a coaxial cable construction that implements SiO₂ material as a dielectric but implements a braid formed of SiO₂ fibers that are braided in the cable construction. That is, the invention eliminates an SiO₂ extruded core and all the physical and performance issues that such an extruded core presents, as noted above. More specifically, the present invention provides a coaxial cable that is constructed with a unique manufacturing process wherein SiO₂ material is braided onto the center conductor rather than being extruded onto the conductor. Fibers of SiO₂ material are formed in a braid having one or more braid layers. The outer conductor is then formed over the SiO₂ braid and then one or more strength layers and jacket layers may be applied. By braiding the SiO₂ material onto the center conductor, the present invention presents a flexible cable and removes the concerns of a cracking extruded dielectric. To address coverage issues not present in an extruded core, the dielectric is braided in layers so that the coverage over the center conductor is provided in a way that eliminates a direct line of sight between the center conductor and the outer conductor.

In accordance with one embodiment of the invention, a form of SiO₂ fibers that are hydrophobic are used to make the cable core. Specifically, the fibers are made from material that in an initial form is a crystalline structure quartz material, which is then ground down and fused so that in a final bonded form, the fiber a non-porous amorphous SiO₂ fiber that is hydrophobic in nature. Since the SiO₂ braid and fiber material does not absorb significant moisture, the braid can be utilized in traditional flexible coaxial cable construction, such as using a helically wrapped outer conductor, which presents openings in the outer conductor for improved flexibility. The hydrophobic nature of the braided SiO₂ core having a quartz-like structure, as opposed to a porous, hydroscopic extruded core allows for higher velocity of propagation and lower loss due to the core layer not absorbing moisture. By combining both the braided SiO₂ core over the center conductor and a helically wrapped outer conductor over the SiO₂ braid, one embodiment of the cable is provided that offers all the temperature and performance advantages of SiO₂, but in a very flexible package without the concerns of brittleness and damage to the extruded core. The construction of the core has advantages in other cable constructions as well.

The cable of the invention is able to operate at high temperatures with a linear phase versus temperature response. Because of the braided SiO₂ core layer, the cable has good phase stability and low loss over extreme temperatures and pressures. Furthermore, the cable provides a high velocity of signal propagation. The velocity of propagation is increased as a result of the voids in the braided layers of the SiO₂ braided core. The unique and a novel manufacturing approach and construction makes it is simpler to manufacture than previous cable designs and eliminates the need for hermetic sealing of the cable at its ends due to the hydrophobic structure of the SiO₂ braided core that is used. As such, traditional termination forms and connectors may be used for terminating the inventive cable.

The dielectric withstanding voltage (DWV) of the inventive cable is addressed and improved by layering the braided core in sublayer braid components. This offsets gaps in a braided sublayer. The cable meets DWV parameters and levels of cables of a similar size with a traditional extruded core. Also, the voltage standing wave ratio (VSWR) performance is exceptional with the inventive cable while maintaining desirable insertion loss characteristics. Furthermore, the inventive cable maintains desirable phase versus temperature characteristics in line with a traditional SiO₂ extruded core, without the drawbacks of the brittle core.

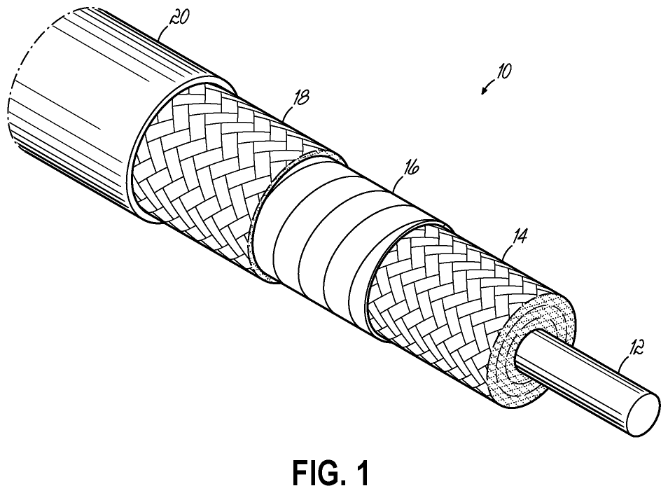

FIG. 1 is a perspective view, in partial cross-section, showing those components of a coaxial cable in accordance with one embodiment of the invention. Specifically, the cable 10 incorporates a center conductor 12, a braided dielectric core layer 14, an outer conductor layer 16, a strength layer 18, and a jacket layer 20. The center conductor may be a suitable conductive material or metal, such as copper or other suitable materials and metals conventionally utilized for conducting electrical signals. The center conductor 12 may be a solid or stranded conductor.

In accordance with one feature of the invention, the dielectric core layer 14 is a braided core layer formed utilizing braided fibers made of silicon dioxide (SiO₂). The fibers are braided around center conductor 12 to form the braided core layer 14. More specifically, to form core layer 14, one or more layers of SiO₂ fiber are braided around the center conductor to yield the desired outer diameter for specific size and electrical characteristics of the cable 10. In accordance with one feature of the invention, braided core layer 14 is configured to provide a flexible SiO₂ dielectric layer, while providing coverage over the center conductor 12 in a way that eliminates a direct line of sight between the center conductor 12 and the outer conductive layer or outer conductor 16. In that way, cable 10 maintains desirable dielectric withstanding voltage (DWV) characteristics and avoids potential DWV breakdown issues.

According to one aspect of the invention, the braid is formed utilizing fibers that are a fused, non-porous, amorphous form of SiO₂ that is hydrophobic. That is, the braided SiO₂ core layer 14 does not have a potential to absorb significant moisture. Therefore, the braided SiO₂ core layer 14 may provide greater flexibility and may be implemented in combination with a flexible outer conductor layer 16 so that cable 10 may be utilized in a traditional flexible coaxial cable construction.

For example, in one embodiment of the invention as illustrated in FIG. 1, the outer conductor layer 16 is a wrapped layer, such as a helically wrapped tape or foil layer that may be used to provide improved flexibility for the cable 10. However, in such a helically wrapped layer, there are openings presented in the outer conductor layer 16. Therefore, the nature of the braided SiO₂ core layer 14 allows the use of that wrapped outer conductor layer 16 without significant moisture concern. By combining both the braided SiO₂ core layer 14 and a wrapped outer conductor layer 16, such as a helically wrapped tape, cable 10 may provide a very flexible cable having all the advantages of using SiO₂ without the concerns of a traditional brittle extruded SiO₂ core as in previous cable solutions. Furthermore, cable 10 does not have to be hermetically sealed at the connector interface. As such, cable 10 and its design may be provided as a solution to replace traditional flat phase FEP/PFA foam core designs.

In the embodiment of the cable 10 illustrated in FIG. 1, the outer conductor layer 16 is formed of a wrapped tape or foil that is wrapped in a helical overlap fashion to provide full coverage over the braided core layer 14 for desired electrical characteristics of the cable. For example, the overlap percentage of the wraps to form the layer may be in the range of 35%-50% overlap. The wrapped outer conductor is formed of a suitable electrically conductive tape/foil material, such as including one or more metal layers. In one embodiment of the invention, the outer conductor is made using two metal materials forming the tape or foil. For example, copper is utilized as one tape layer material and stainless steel is utilized as another tangential tape layer material on a side of the copper. The copper facing layer faces inwardly in the wraps, toward the center conductor 12, and the stainless steel is positioned on the outside of the tape layer. In that way, the outer conductor 16 provides high electrical connectivity features for the internal electrical circuit of the cable 10 while still providing strong corrosion resistance to the external environment on the outside of the outer conductor layer 16. In another embodiment, a layer of silver over a layer of copper may be used for the tape. Alternatively, silver and copper may be woven into a braid to form the outer conductor 16. In another embodiment of the invention, a carbon tape may be implemented on the outside of the braided SiO₂ core layer. Still further, as discussed herein, a semi-rigid outer conductor, such as a copper or aluminum tube, may be used as the outer conductor for a semi-rigid cable.

In one embodiment, to complete the cable construction 10, an outer strength layer 18 may be utilized. For example, the outer strength layer 18 may be a braided layer utilizing fibers, such as Kevlar fibers or other aramid fibers to provide protection and high tensile strength to the cable. Other materials forming the strength layer 18 may include glass fibers interwoven with other composite or aramid fibers, such as Kevlar, nylon and others. The present invention is not limited with respect to the formation of the strength layer 18.

Finally, one or more outer jacket layers 20 may be utilized for the completion of the cable construction of cable 10. Such jacket layers are conventionally known and may be made of a number of different materials, such as FEP, TEFZEL, PFA, etc. The composition of the jacket layer 20 is also not limiting with respect to the present invention.

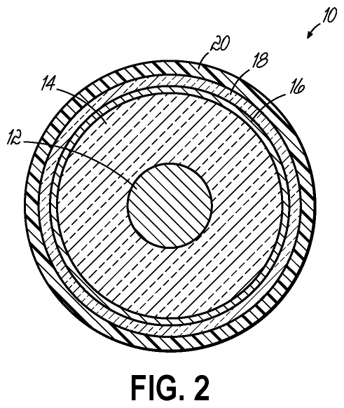

FIG. 2 illustrates a cross-sectional view of cable 10 showing the various layers of center conductor 12 and the braided SiO₂ core layer 14. The relative thickness of the various layers is shown only for illustrative purposes. FIG. 2 does not reflect the actual layers and layer thicknesses relative to each other. It would be understood by a person of ordinary skill in the art that the center conductor 12 as well as the thickness of the braided SiO₂ core layer 14, the outer conductor layer 16 and the other remaining layers 18, 20 will vary depending upon the desired electrical and physical characteristics of the cable.

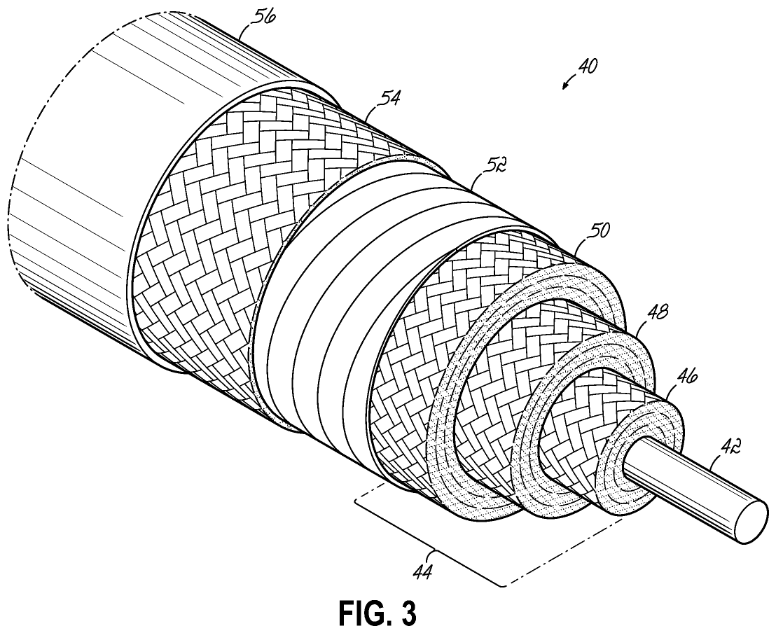

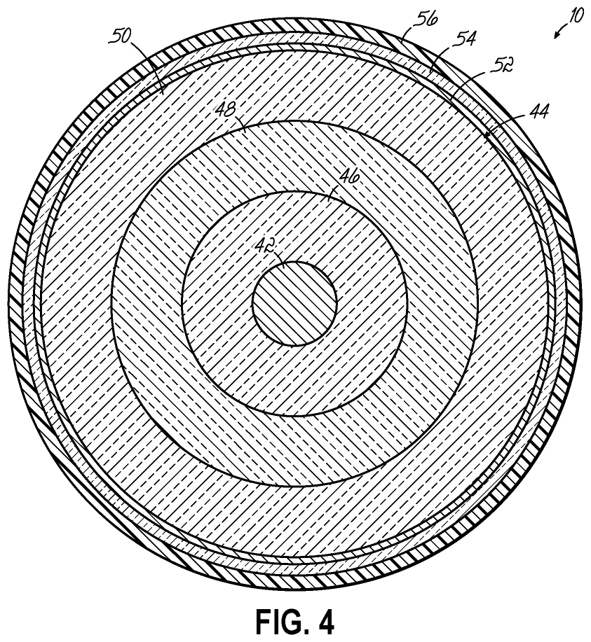

FIGS. 3 and 4 illustrate an alternative embodiment of the invention wherein the braided SiO₂ core layer of the cable incorporates multiple layers, one on top of each other, to build up the overall braided SiO₂ core layer to the desired thickness. Such a unique construction provided an overlap characteristic such that the braided core layer has the desired thickness and also the line of sight distance characteristics between the outer conductor layer and the center conductor are addressed to resolve any potential DWV breakdown issues. More specifically, FIG. 3 incorporates a center conductor 42, a braided SiO₂ core layer 44, an outer conductive layer 52, one or more strength layers 54 and one or more jacket layers 56. As shown in FIG. 3, the braided SiO₂ core layer is made of a plurality of braided sublayers 46, 48, 50 that are each braided over the center connector 42 and over a previous braided sublayer to form the overall braided SiO₂ core layer 44 of a specific thickness or outer diameter. In accordance with one aspect of the invention, each of the braided sublayers 46, 48, 50 may be braided utilizing different braiding parameters such that each of the layers is slightly different in its braid characteristics than a previous sublayer. In that way, the sublayers 46, 48, and 50 of the braided SiO₂ core cable 44 may be adjusted to achieve the desired physical electrical characteristics of the cable 40. For example, the multiple layering of braided sublayers provided by the braided SiO₂ core layer 44 results in greater coverage in order to improve DWV performance.

In one embodiment of the invention SiO₂ fibers in the form of yarns are woven into multiple layers over the center conductor? One suitable fiber material is Quartzel plant fibers available from St. Gobain Quartz USA of Louisville, Kentucky. More particularly, the QS 1318 size Quartzel yarn is utilized consisting of a plurality of 9 micron fibers and having a US customary system designation of 300 2/4 QS 13 4Z 3.8 S yarn that has four plies of two strands of the filaments twisted together to yield a nominal linear density yarn of 133 tex.

For braid construction and use as a braided SiO₂ dielectric layer in accordance with the invention, one end of the fibers is used per bobbin for each of the three layers as shown in FIGS. 3 and 4. In one embodiment, the bobbins used are NEB fine No. 2 wire bobbin with a 2.75 inch traverse, with each bobbin holding 120 g of material. To braid the first layer 46 over the center conductor, a 16-carrier NED Butt braider is run at a half load. That is four carriers are running in one direction and four carriers are running in another direction, with all the carriers equally spaced. An over braid is applied to the center conductor 42 with 25 picks per inch (+/−1). The outer diameter, upon the application of the first layer 46 is 0.060 inches (+/−0.002″). Next, to form layer 48, the braided SiO₂ yarn is applied using a similar 16-carrier NEB Butt braider running again at half load with the four carriers running in one direction and four carriers running in another direction with all carriers equally spaced. Layer 48 is applied as an over braid to layer 46 with a 20 picks per inch (+/−1) construction. This adds to the outer diameter to bring it up to approximately 0.075 inches (+/−0.002″). Finally, layer 50 is applied with a similar 12-carrier NEB Butt braider. However, for layer 50, the operator is running at a full load with all 12 carriers being used to form an over braid layer applied to the two previous layers 46, 48 at a construction of 20 picks per inch (+/−1). This brings the outer diameter for the braided coil layer 44 to 0.090 inches (+/−0.002″). Thereafter, once the braided core layer 44 is formed having multiple sublayers 46, 48, 50, the outer conductor may be formed on the core. Depending upon the finished cable design, such as if it for a flexible cable or semi-rigid or rigid cable, different outer conductor constructions may be implemented.

For a flexible cable embodiment of the invention, referring to FIG. 3, the outer conductor layer 52 may incorporate a wrapped tape layer. In one embodiment a foil tape, such as a copper/stainless steel tape as discussed herein may be used. The tape may be helically wrapped as shown in FIG. 3, to form the outer conductor. Then the strength layer 54 is braided or otherwise applied over the outer conductor and the jacket 56 is extruded or otherwise applied to the strength layer 54 to complete the cable instruction. The materials of the outer conductor 52, strength layer 54 and jacket 56 may be similar to the materials noted with respect to the embodiment 10 in FIGS. 1 and 2.

FIG. 4 illustrates a cross-sectional view of the embodiment 40 of the inventive cable illustrated in FIG. 3. The braided sub layers 46, 48 and 50 are illustrated showing their relative position within the braided SiO₂ core layer and their overall thickness versus the thickness of the additional layers 52, 54, 56 for illustrative purpose only, with no particular relative dimensional construction implied or limiting in the invention.

In the construction of the wrapped outer conductor of FIGS. 1, 3, the tape may be helically wrapped, as noted, with an overlap in the range of 35%-50% overlap to form a conductive layer having a 0.001-0.012 inch thickness giving an overall outer diameter of approximately 0.098 inches to the cable. The strength layer 54 may have a relative thickness of 0.001-0.012 inches yielding an outer diameter for that layer of 0.110 inches. Finally, the jacket layer 56 may have a thickness of 0.001-0.022 inches yielding an overall diameter of the cable of approximately 0.130 inches. Of course it will be understood by a person of ordinary skill in the art that a cable using the invention may be constructed with a number of different dimensions to achieve the desired impedance and other electrical characteristics.

While Quartzel yarns are illustrated in one embodiment, the present invention is not limited to that particular brand of SiO₂ fibers. Other suitable SiO₂ yarns may be utilized for forming the braided SiO₂ core layer 14, 44 or 64 as disclosed herein.

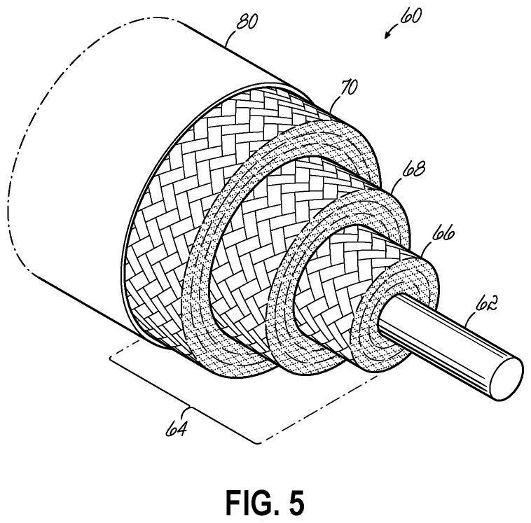

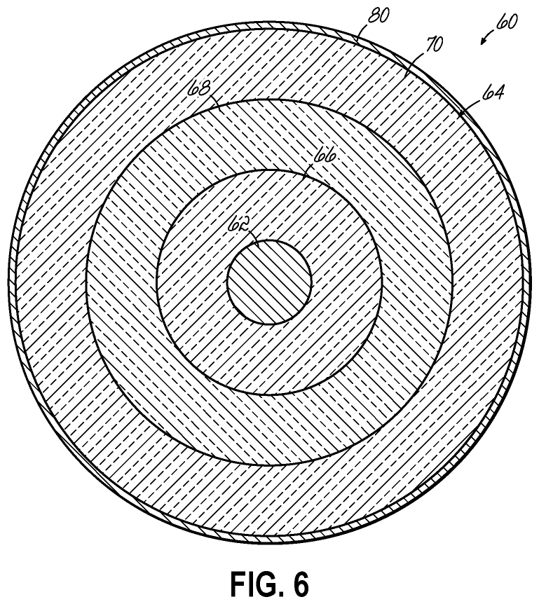

FIGS. 5 and 6 illustrate still another alternative embodiment of the invention for a rigid or semi rigid design. The cable 60 implements a braided SiO₂ core layer having multiple layers, one on top of each other, to build up the overall braided SiO₂ core layer to the desired thickness similar to the embodiment of FIGS. 3-4. More specifically, FIG. 5 incorporates a center conductor 62, a braided SiO₂ core layer 64 and an outer conductive layer 80 that may be formed to be generally rigid or semi-rigid. For example, the outer conductor may be a copper tube into which the center conductor 62 and braided core 64 is inserted. In an alternative embodiment, the outer conductive layer may be a semi-rigid layer that has an inner material of copper and an outer material of stainless steel. As shown in FIG. 5, the braided SiO₂ core layer may be made of a plurality of braided sublayers 66, 68, 70 that are each braided over the center connector 62 and over a previous braided sublayer to form the overall braided SiO₂ core layer 64 of a specific thickness or outer diameter. As noted, each of the braided sublayers may be braided utilizing different braiding parameters such that each of the layers is slightly different in its braid characteristics than a previous sublayer to achieve the desired coverage over the center conductor for the desired physical and electrical characteristics of the cable. The braided core 64 may be formed as discussed herein for the embodiment of FIGS. 3-4. In such a rigid or semi-rigid construction, strength layers and outer jackets would not be implemented. A semi-rigid outer conductor 80, such as a semi-rigid conductive tube formed of copper or aluminum, or of copper and stainless steel, may form the outer conductor element with the center conductor and braided dielectric core layer being inserted inside the semi-rigid conductive tube to complete the cable, as is known in semi-rigid cable construction. The semi-rigid embodiment would have the desired characteristics of the flexible embodiment using the braided SiO₂ dielectric core layer.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A cable comprising:
a center conductor;
a dielectric core layer, the dielectric core layer including at least one layer formed of silicon dioxide fibers;
the silicon dioxide fibers being braided around the center conductor and forming a braided dielectric core layer over the center conductor;
an outer conductor layer formed over the braided dielectric core layer.

2. The cable of claim 1 further comprising a strength member layer formed over the outer conductor layer.

3. The cable of claim 2 further comprising a jacket layer formed over the strength member layer.

4. The cable of claim 1 wherein the braided dielectric core layer includes a plurality of sublayers formed of silicon dioxide fibers, the sublayers being braided successively over the center conductor to form the braided dielectric core layer.

5. The cable of claim 4 wherein at least two of the sublayers of silicon dioxide fibers are braided using differing braiding parameters to provide improved coverage of the braided dielectric core layer over the center conductor.

6. The cable of claim 4 wherein the braided dielectric core layer includes at least three sublayers of silicon dioxide fibers, each of the at least three sublayers being braided using differing braiding parameters to provide improved coverage over the center conductor.

7. The cable of claim 1 wherein the outer conductor layer formed over the braided core layer includes a conductive tape wrapped around the braided dielectric core layer.

8. The cable of claim 7 wherein the conductive tape includes at least one of a layer of copper and stainless steel.

9. The cable of claim 7 wherein the conductive tape has a copper layer on one side and a stainless steel layer on a side opposite the copper layer, the conductive tape wrapped around the braided dielectric core layer with the copper layer facing the center conductor.

10. The cable of claim 1 wherein the outer conductor layer formed over the braided core layer includes a semi-rigid conductive tube, the center conductor and braided dielectric core layer being inserted inside the semi-rigid conductive tube.

11. A method of forming a cable comprising:
providing a center conductor;
braiding at least one layer of silicon dioxide fibers around an outer surface of the center conductor for forming a braided dielectric core layer over the center conductor;
forming an outer conductor layer over the braided core layer to form the cable.

12. The method of claim 11 further comprising forming a strength member layer over the outer conductor layer.

13. The method of claim 12 further comprising forming a jacket layer over the strength member layer.

14. The method of claim 1 further comprising successively braiding a plurality of sublayers of silicon dioxide fibers over the center conductor to form the braided dielectric core layer.

15. The method of claim 14 further comprising braiding at least two of the sublayers of silicon dioxide fibers using differing braiding parameters to provide improved coverage of the braided dielectric core layer over the center conductor.

16. The method of claim 14 further comprising braiding at least three sublayers of silicon dioxide fibers over the center conductor, each of the at least three sublayers being braided using differing braiding parameters to provide improved coverage of the braided dielectric core layer over the center conductor.

17. The method of claim 11 wherein forming an outer conductor layer over the braided core layer includes wrapping a conductive tape around the braided dielectric core layer.

18. The method of claim 17 wherein the conductive tape includes at least one of a layer of copper and stainless steel.

19. The method of claim 17 wherein the conductive tape has a copper layer on one side and a stainless steel layer on a side opposite the copper layer, the method further comprising wrapping the conductive tape around the braided dielectric core layer with the copper layer facing the center conductor.

20. The method of claim 11 wherein the outer conductor layer formed over the braided core layer includes a semi-rigid conductive tube, the method further comprising inserting the center conductor and braided dielectric core layer inside the semi-rigid conductive tube.
